(19) United States
(12) Patent Application Publication
(10) Pub. No.: US 2018/0260268 A1
(43) Pub. Date: Sep. 13, 2018

(54) SELF-LEARNING EVENT RESPONSE ENGINE OF SYSTEMS

(71) Applicant: SEAGATE TECHNOLOGY LLC, Cupertino, CA (US)

(72) Inventors: Christian B. MADSEN, Longmont, CO (US); Dmitriy VASSILYEV, Longmont, CO (US); Michael MCKAY, Wellesley (CA); Marcin LIZON, Waterloo (CA)

(73) Assignee: SEAGATE TECHNOLOGY LLC, Cupertino, CA (US)

(21) Appl. No.: 15/454,252

(22) Filed: Mar. 9, 2017

(51) Int. Cl. G06F 11/07

(52) U.S. Cl. CPC G06F 11/0727; G06F 11/0793; G06F 11/079; G06F 11/0751

(57) ABSTRACT

Systems and methods for a self-learning event response engine of systems are described. In one embodiment, the systems and methods may include identifying two or more patterns of events among a plurality of detected events stored in a database, identifying an adverse condition of the storage system that occurs as a result of a particular pattern of events from the identified patterns of events, identifying a corrective action that resolves the adverse condition of the storage system, detecting an occurrence of one or more events from the particular pattern of events, and implementing the corrective action based at least in part on detecting the occurrence of the one or more events from the particular pattern of events.

### SUMMARY

The present disclosure is directed to methods and systems for a self-learning event response engine of systems. In some embodiments, the present systems and methods may log detected events, analyze patterns among the logged detected events, and create action rules based on the analyzed patterns. For example, the present systems and methods may include identifying frequent event patterns in relation to the operation of a storage system and automating action rules to preemptively circumvent storage system errors based on the identified frequent event patterns.

A storage system for a self-learning event response engine of systems is described. In one embodiment, the storage system may include a storage drive and a controller. In some embodiments, the storage system may include a processor and memory in electronic communication with the processor. The memory may store computer executable instructions that when executed by the processor cause the processor to perform the steps of identifying two or more patterns of events among a plurality of detected events stored in a database, identifying an adverse condition of the storage system that occurs as a result of a particular pattern of events from the identified patterns of events, selecting a corrective action that resolves the adverse condition of the storage system, detecting an occurrence of one or more events from the particular pattern of events, and implementing the corrective action based at least in part on detecting the occurrence of the one or more events from the particular pattern of events.

In some cases, each pattern of events may include a sequence of two or more events in a given order related to operations of the storage system, the storage system comprising a storage drive, a storage server, a storage enclosure enclosing two or more storage drives, a distributed data storage system, a cloud storage system, or any combination thereof. In some cases, the adverse condition may include an abnormal operation of the storage system, an abnormal operating condition of the storage system, a hardware failure, a software bug, a firmware bug, unavailability of the storage system, a loss of data stored on the storage system, or any combination thereof. In some cases, one or more of the plurality of detected events stored in the database may indicate an event type, an event trigger, an event severity level, a pattern severity level, or any combination thereof.

In some embodiments, the instructions may cause the processor to perform the steps of ranking the identified patterns of events based at least in part on their frequency of occurrence, the event severity level, the pattern severity level, or any combination thereof. In some embodiments, the instructions may cause the processor to perform the steps of detecting the occurrence of the one or more events being based at least in part on the ranking of the identified patterns of events. In some embodiments, the instructions may cause the processor to perform the steps of calculating a time period expected to lapse between two events in the particular pattern of events. In some embodiments, the instructions may cause the processor to perform the steps of estimating, based at least in part on the calculated time period. In some cases, the calculated time period may include a mean time, a median time, an average time, or some other characteristic time before the adverse condition occurs in relation to detecting the occurrence of the one or more events from the particular pattern of events.

In some embodiments, the instructions may cause the processor to perform the steps of implementing the identified corrective action based at least in part on the event severity level, the pattern severity level, the rank of the particular pattern of events, the calculated time period, the estimated mean time before the adverse condition occurs, a cost of the corrective action, a cost of implementing the corrective action immediately versus a cost of implementing the corrective action after waiting a predetermined time period, current storage system performance, a service agreement, a device warranty, or any combination thereof.

In some cases, the event severity level of the particular pattern of events may be based at least in part on a position of a specific event from the particular pattern of events relative to other events in the particular patterns of events, and the pattern severity level of the particular pattern of events being based at least in part on a severity of the adverse condition caused by the particular pattern of events. In some cases, the corrective action may include at least one of deleting a file, downloading a file, implementing a file, saving a file in a file system folder stored on a storage medium of the storage system, saving a file in a certain location of the storage medium of the storage system, installing a program, updating a program, installing firmware, upgrading firmware, repairing a hardware component, replacing a hardware component, sending a notification, or any combination thereof.

A method for a self-learning event response engine of systems is also described. In one embodiment, the method may include identifying two or more patterns of events among a plurality of detected events stored in a database, identifying an adverse condition of the storage system that occurs as a result of a particular pattern of events from the identified patterns of events, selecting a corrective action that resolves the adverse condition of the storage system, detecting an occurrence of one or more events from the particular pattern of events, and implementing the corrective action based at least in part on detecting the occurrence of the one or more events from the particular pattern of events.

A non-transitory computer-readable storage medium for a self-learning event response engine of systems is also described. In some embodiments, the non-transitory computer-readable storage medium may store computer executable instructions that when executed by a processor cause the processor to perform the steps of identifying two or more patterns of events among a plurality of detected events stored in a database, identifying an adverse condition of the storage system that occurs as a result of a particular pattern of events from the identified patterns of events, selecting a corrective action that resolves the adverse condition of the storage system, detecting an occurrence of one or more events from the particular pattern of events, and implementing the corrective action based at least in part on detecting the occurrence of the one or more events from the particular pattern of events.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, including their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components, including those having a dash and a second reference label, apply to other similar components. If only the first reference label is used in the specification, the description is applicable to any one of the similar components having the same first reference label irrespective of the second reference label.

FIG. 1 is a block diagram of an example of a system in accordance with various embodiments;

FIG. 2 shows a block diagram of a device in accordance with various aspects of this disclosure;

FIG. 3 shows a block diagram of one or more modules in accordance with various aspects of this disclosure;

FIG. 4 shows a diagram of a system in accordance with various aspects of this disclosure;

FIG. 5 shows a diagram of a system in accordance with various aspects of this disclosure;

FIG. 6 shows a diagram of database entries in accordance with various aspects of this disclosure;

FIG. 7 is a flow chart illustrating an example of a method in accordance with various aspects of this disclosure; and

FIG. 8 is a flow chart illustrating an example of a method in accordance with various aspects of this disclosure.

### DETAILED DESCRIPTION

The following relates generally to a self-learning event response engine. More specifically, the systems and methods include a framework, process flow, and implementation of a self-learning event response engine for storage systems. The storage systems may include computer systems with storage such as desktop computers, laptop computers, mobile computers, and the like. In some cases, the storage systems may include dedicated storage systems such as storage servers, storage enclosures, cloud storage systems, distributed storage systems, and the like.

For a system with any kind of event log and relevant contextual information, in particular severity and corrective action, the present systems and methods apply structured data mining to find sequences in the data that can be used to predict events of relevant severity and implement more timely service. Structure mining or structured data mining, such as graph mining or sequential pattern mining, includes the process of finding and extracting useful information from semi-structured data sets. Sequential pattern mining includes finding statistically relevant patterns between data examples where the values are delivered in a sequence. Some problems in sequence mining lend themselves to discovering frequent itemsets and in some cases the order in which the frequent itemsets or the items of the itemsets appear. For example, by analyzing transactions of customer shopping baskets in a supermarket, one can produce a rule based on a frequent itemset of when a customer buys onions and potatoes together, the customer is likely to also buy hamburger meat in the same transaction. Similarly, by analyzing event logs of storage systems, the present systems and methods may produce a rule based on a frequent itemset of when events A, B, C, and D occur together in that particular order with certain time intervals between each event, the storage system is likely to experience a failure of a certain severity.

In one embodiment, the present systems and methods may include detecting events of a storage system. In some examples, the present systems and methods may log the detected events, failures occurring in relation to events, and/or corrective actions of the failures. In some cases, a log of the one or more events may include a trigger for at least one of the events. In some cases, the log may include a severity rating for at least one of the events or for a sequence of events. In some cases, the present systems and methods may associate a corrective action with the one or more events. In one embodiment, the present systems and methods may analyze the events. In some cases, the present systems and methods may perform structured pattern mining on the events to identify frequently occurring sequences of events associated with a failure of the storage system. In some embodiments, the present systems and methods may create and/or expand a prioritized list of sequences of events associated with corrective actions that may be taken before a failure associated with a particular sequence of events. In some cases, the present systems and methods may generate an action rule for a particular sequence of events. In some cases, upon detecting one or more events in a certain order associated with a particular sequence of events, the present systems and methods may implement an action rule that enables the storage system to automatically and programmatically implement a corrective action without human intervention.

The present systems and methods describe systems equipped with such a log in relation to event-based telemetry. Certain events trigger a call back with information to a monitoring system. The monitoring system or a system connected to the monitoring system stores sequences of telemetry and the systems and methods run sequential pattern mining to determine what sequences may be predictive, indicative, or characteristic of service/support events. As the event log matures, the present systems and methods may associate corrective actions taken with certain events and/or certain patterns of events. In some cases, the present systems and methods may optimize discovered event sequences and corresponding opportunities for corrective actions in relation to certain parameters (e.g., cost, service agreements, performance, etc.) to decide what action to take and when to take the action. The present systems and methods provide a codeable and automatable flow for correlation of the event log to proactive/timely corrective actions and enabling a self-contained, self-learning system for event response.

In some embodiments, the present systems and methods may be configured to identify a sequence of events that frequently leads to a certain error. In some cases, the present systems and methods may identify an average time period between events in the sequence of events. For example, the present systems and methods may identify a sequence of events A, B, C and D. In some cases, the present systems and methods may determine that event A occurs on average every 30 days, that event B usually occurs within 5 to 7 days after event A, that event C occurs within an hour after event B, and that event D on average occurs 2 days after event C.

In some cases, the present systems and methods may determine when corrective action is typically taken in relation to the time periods between events of a given sequence of events. For example, the present systems and methods may determine that for a sequence of events A, B, C and D, that corrective action is typically taken after events A, B, C occur and before event D occurs. In some cases, the present systems and methods may determine a cost associated with taking corrective action after event A, after event B, after event C, and/or after event D occur. In one example, the present systems and methods may determine that the most cost effective time to take the corrective action is after events A, B occur, and before events C, D occur.

In some embodiments, the present systems and methods may rank identified sequences of events according to their frequency. For example, the present systems and methods may identify the top 10 most frequently occurring sequence of events, or the top 100 most frequently occurring sequence of events, etc. In some cases, the present systems and methods may rank identified sequences according to a severity of a failure caused by a sequence of events. For example, the present systems and methods may identify the top 10 sequence of events in relation to the most severe failures, etc. In some embodiments, the present systems and methods may identify corrective actions taken in relation to the sequence of events. In some cases, the present systems and methods may identify the most common corrective action taken in relation to a particular sequence of events. In some cases, the present systems and methods may identify at least one less commonly taken corrective action. As one example, the present systems and methods may identify the top three corrective actions and associate the top three corrective actions with a corresponding sequence of events where the top three relate to the three most used and/or the three most effective corrective actions.

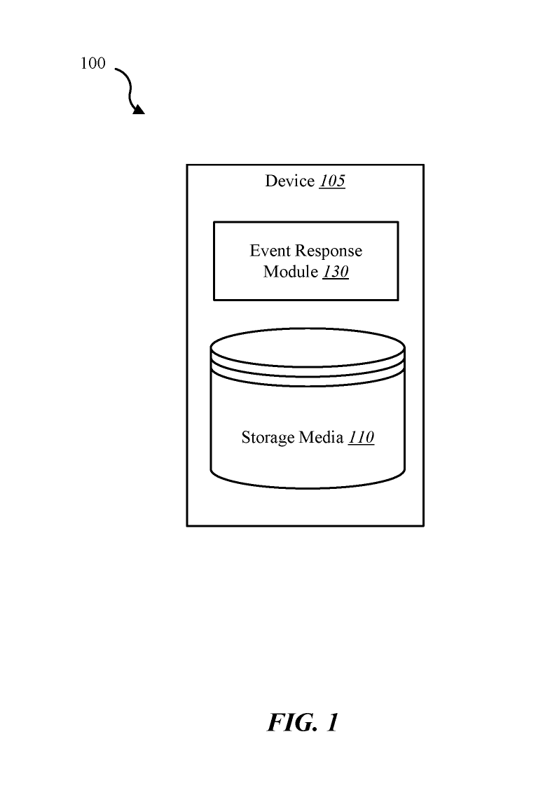

FIG. 1 is a block diagram illustrating one embodiment of an environment 100 in which the present systems and methods may be implemented. The environment may include device 105 and storage media 110. The storage media 110 may include any combination of hard disk drives, solid state drives, and hybrid drives that include both hard disk and solid state drives. In some embodiment, the storage media 110 may include shingled magnetic recording (SMR) storage drives. In some embodiments, the systems and methods described herein may be performed on a single device such as device 105. In some cases, the methods described herein may be performed on multiple storage devices or a network of storage devices such a cloud storage system and/or a distributed storage system. Examples of device 105 include a storage server, a storage enclosure, a storage controller, storage drives in a distributed storage system, storage drives on a cloud storage system, storage devices on personal computing devices, storage devices on a server, or any combination thereof. In some configurations, device 105 may include an event response module 130. In one example, the device 105 may be coupled to storage media 110. In some embodiments, device 105 and storage media 110 may be components of flash memory or a solid state drive. Alternatively, device 105 may be a component of a host of the storage media 110 such as an operating system, host hardware system, or any combination thereof.

In one embodiment, device 105 may be a computing device with one or more processors, memory, and/or one or more storage devices. In some cases, device 105 may include a wireless storage device. In some embodiments, device 105 may include a cloud drive for a home or office setting. In one embodiment, device 105 may include a network device such as a switch, router, access point, or any combination thereof. In one example, device 105 may be operable to receive data streams, store and/or process data, and/or transmit data from, to, or in conjunction with one or more local and/or remote computing devices.

The device 105 may include a database. In some cases, the database may be internal to device 105. In some embodiments, storage media 110 may include a database. Additionally, or alternatively, the database may include a connection to a wired and/or a wireless database. Additionally, as described in further detail herein, software and/or firmware (for example, stored in memory) may be executed on a processor of device 105. Such software and/or firmware executed on the processor may be operable to cause the device 105 to monitor, process, summarize, present, and/or send a signal associated with the operations described herein.

In some embodiments, storage media 110 may connect to device 105 via one or more networks. Examples of networks include cloud networks, local area networks (LAN), wide area networks (WAN), virtual private networks (VPN), a personal area network, near-field communication (NFC), a telecommunications network, wireless networks (using 802.11, for example), and cellular networks (using 3G and/or LTE, for example), or any combination thereof. In some configurations, the network may include the Internet and/or an intranet. The device 105 may receive and/or send signals over a network via a wireless communication link. In some embodiments, a user may access the functions of device 105 via a local computing device, remote computing device, and/or network device. For example, in some embodiments, device 105 may include an application that interfaces with a user. In some cases, device 105 may include an application that interfaces with one or more functions of a network device, remote computing device, and/or local computing device.

In one embodiment, the storage media 110 may be internal to device 105. As one example, device 105 may include a storage controller that interfaces with storage media of storage media 110. Event response module 130 may detect a storage device related event such as an event that affects the operation of a storage device. In some cases, event response module 130 may detect events that adversely affect the operation of a storage device. In some embodiments, event response module 130 may store the detected event in a log that includes multiple detected events. The log may include detected events from a single storage device or events from two or more storage devices. In some embodiments, event response module 130 may search the log of detected events to identify frequently occurring event patterns. For example, event response module 130 may identify an event pattern such as event A occurring first, then event B after event A, and then event C after event B occurring frequently among all the detected events stored in the log. In some cases, event response module 130 may create a list of frequently occurring event patterns. In some embodiments, event response module 130 may create one or more action rules based on the identified frequently occurring event patterns. For example, event response module 130 may generate an action rule based on an analysis of the event pattern event A, event B, and event C indicating that this event pattern is associated with an adverse operation of the storage device.

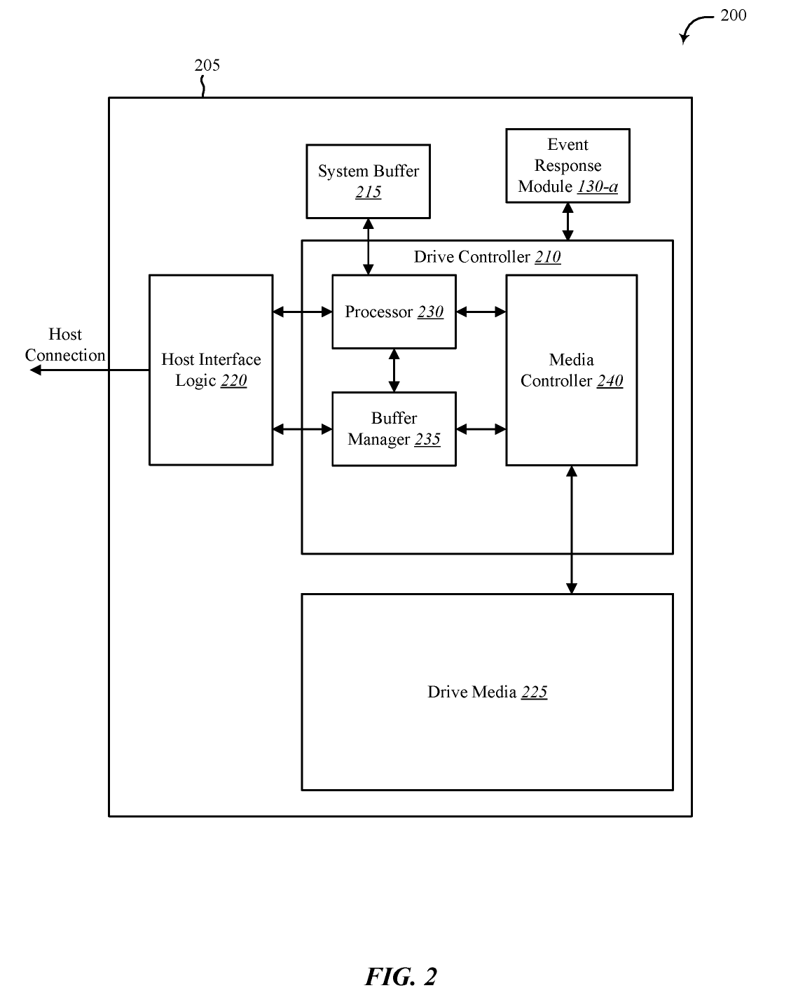

FIG. 2 shows a block diagram 200 of an apparatus 205 for use in electronic communication, in accordance with various aspects of this disclosure. The apparatus 205 may be an example of one or more aspects of device 105 described with reference to FIG. 1. The apparatus 205 may include a drive controller 210, system buffer 215, host interface logic 220, drive media 225, and event response module 130-a. Each of these components may be in communication with each other and/or other components directly and/or indirectly.

One or more of the components of the apparatus 205, individually or collectively, may be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used such as Structured/Platform ASICs, Field Programmable Gate Arrays (FPGAs), and other Semi-Custom ICs, which may be programmed in any manner known in the art. The functions of each module may also be implemented, in whole or in part, with instructions embodied in memory formatted to be executed by one or more general and/or application-specific processors.

In one embodiment, the drive controller 210 may include a processor 230, a buffer manager 235, and a media controller 240. The drive controller 210 may process, via processor 230, read and write requests in conjunction with the host interface logic 220, the interface between the apparatus 205 and the host of apparatus 205. The system buffer 215 may hold data temporarily for internal operations of apparatus 205. For example, a host may send data to apparatus 205 with a request to store the data on the drive media 225. Drive media 225 may include one or more disk platters, flash memory, any other form of non-volatile memory, or any combination thereof. The driver controller 210 may process the request and store the received data in the drive media 225. In some cases, a portion of data stored in the drive media 225 may be copied to the system buffer 215 and the processor 230 may process or modify this copy of data and/or perform an operation in relation to this copy of data held temporarily in the system buffer 215.

Although depicted outside of drive controller 210, in some embodiments, event response module 130-a may include software, firmware, and/or hardware located within drive controller 210. For example, event response module 130-a may include at least a portions of processor 230, buffer manager 235, and/or media controller 240. In one example, event response module 130-a may include one or more instructions executed by processor 230, buffer manager 235, and/or media controller 240.

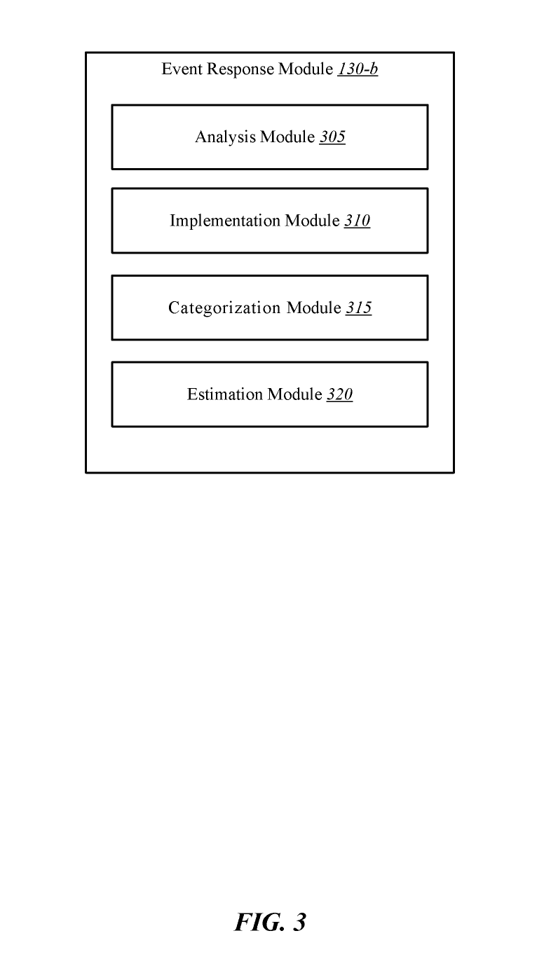

FIG. 3 shows a block diagram of an event response module 130-b. The event response module 130-b may include one or more processors, memory, and/or one or more storage devices. The event response module 130-b may include analysis module 305, implementation module 310, categorization module 315, and estimation module 320. The event response module 130-b may be one example of event response module 130 of FIGS. 1 and/or 2. Each of these components may be in communication with each other. In some examples, event response module 130 may include or operate in conjunction with one or more processors and memory in electronic communication with the one or more processors. In some cases, event response module 130 may include computer executable instructions that when executed by the processor cause the processor to perform certain operations as explained herein

In one embodiment, analysis module 305 may be configured to identify one or more patterns of events among a plurality of detected events stored in a database. In some embodiments, each pattern of events includes a sequence of two or more events in a given order related to operations of at least one storage system. In some cases, the storage system includes a storage drive, a storage server, a storage enclosure enclosing two or more storage drives, a distributed data storage system, a cloud storage system, or any combination thereof.

In some embodiments, events associated with one or more storage systems may be collected and stored in a database. In some cases, analysis module 305 may be configured to implement a structured pattern mining algorithm. As one example, analysis module 305 may be configured to identify patterns of events based at least in part on implementing a structured pattern mining algorithm. In some examples, the structured pattern mining algorithm may be configured to identify patterns of events among the detected events stored in the database.

In some embodiments, analysis module 305 may be configured to identify an adverse condition of the storage system that occurs as a result of a particular pattern of events from the identified patterns of events. In some cases, the adverse condition may include an abnormal operation of the storage system, an abnormal operating condition of the storage system, a hardware failure, a software bug, a firmware bug, unavailability of the storage system, a loss of data stored on the storage system, or any combination thereof. In some embodiments, one or more of the plurality of detected events stored in the database indicate an event type, an event trigger, an event severity level, a pattern severity level, or any combination thereof.

In some cases, the event severity level of the particular pattern of events may be based at least in part on a position of a specific event from the particular pattern of events relative to other events in the particular patterns of events. In some cases, the pattern severity level of the particular pattern of events may be based at least in part on a severity of the adverse condition caused by the particular pattern of events. For example, a severity level of an event may be based at least in part on a severity of an adverse condition that results from a certain sequence of events, of which the event is one of the events in the sequence of events. In some cases, a severity level of an event may be based on how likely an adverse condition is to occur based on the occurrence of the detected event. For example, upon detecting event Q from the sequence QRST the event Q may be given a relatively low severity level due to events R, S and T having to occur before the adverse condition. Thus, R may have a higher severity level than Q, S a higher severity level than R, and so forth. In some cases, a severity level of a particular event may be affected by a severity level of the adverse condition that occurs as a result of the sequence of events.

As one example, analysis module 305 may identify a sequence of events that leads to a particular error or failure in relation to a storage system. In some embodiments, analysis module 305 may be configured to identify a corrective action that resolves the adverse condition of the storage system. In some cases, the implementation module 310 may be configured to select a corrective action to implement. For example, the database may store corrective actions taken to resolve certain failures. In some cases, analysis module 305 may rank the corrective actions according to their effectiveness. As an example, analysis module 305 may determine whether a first corrective action resolves the same failure better than a second corrective action. For instance, analysis module 305 may determine that the first corrective action costs less than the second corrective action, that the first corrective action takes less time and/or resources to implement than the second corrective action, that implementing the first corrective action results in less recurrences of the failure than the second corrective action, or any combination thereof. Additionally, or alternatively, analysis module 305 may rank corrective actions based on frequency of use. For example, a certain sequence of events may frequently result in a particular failure. For each occurrence of the failure, one of two or more corrective actions may be taken to resolve the failure. Over time, analysis module 305 may determine which corrective action is used the most.

In some embodiments, analysis module 305 may be configured to detect an occurrence of one or more events from the particular pattern of events. For example, analysis module 305 may determine that a particular pattern of events includes events MNOPQ occurring in that particular order, and that the pattern of events MNOPQ results in at least one adverse condition of the relative storage system.

In some cases, analysis module 305 may identify one or more corrective actions that are known to resolve an adverse condition that results from the occurrence of a pattern of events such as the pattern MNOPQ. In some embodiments, implementation module 310 may be configured to implement a selected corrective action based at least in part on detecting the occurrence of the one or more events from the particular pattern of events. For example, analysis module 305 may be configured to monitor for occurrences of event M. Upon detecting event M, analysis module 305 may monitor for event N occurring after event M, and so forth. In each successive occurrence of an event in the pattern of events, analysis module 305 may determine whether to implement a corrective action in conjunction with implementation module 310. For example, implementation module 310 may determine whether to implement a corrective action after analysis module 305 detects the occurrence of event M, after the occurrence of events MN, after the occurrence of events MNO, after the occurrence of events MNOP, or after the occurrence of events MNOPQ, etc.

In one embodiment, categorization module 315 may be configured to rank the identified patterns of events based at least in part on their frequency of occurrence, an event severity level, a pattern severity level, or any combination thereof. In some embodiments, analysis module 305 may be configured to detect the occurrence of the one or more events based at least in part on the ranking of the identified patterns of events. For example, a first sequence of events such as VWXYZ may result in an adverse condition, while a second sequence of events such as MNOPQ may not result in any adverse condition. Accordingly, analysis module 305 may be configured to detect the occurrence of event V, then W, then X, etc., while ignoring the occurrence of event M, then N, then O, etc., because the first sequence VWXYZ is associated with an adverse condition while the second sequence is not.

In one embodiment, estimation module 320 may be configured to calculate a time period expected to lapse between two events in a particular pattern of events. In some cases, estimation module 320 may calculate the time period based at least in part on an average lapse of time between the occurrences of each event in the particular pattern of events. For example, estimation module 320 may calculate the time period that typically occurs between events M and N in the sequence MNOP, calculate the time period that typically occurs between events N and O of the same sequence, and calculate the time period that typically occurs between events O and P in the same sequence. Accordingly, in some embodiments, estimation module 320 may be configured to calculate an estimated time period that lapses on average between each event. As one example, estimation module 320 may determine that the estimated time period that lapses between events of the sequence RDESFJ is 5 days between R then D, 3 hours between D then E, 1 day between E then S, 2 days between S then F, 30 minutes between F then J, and 1 day between J then the adverse condition. In some embodiments, estimation module 320 may be configured to estimate, based at least in part on a calculated time period, a mean time before an adverse condition occurs in relation to detecting the occurrence of one or more events from a particular pattern of events. For example, estimation module 320 may determine a mean time before an adverse condition after the occurrence of R from sequence RDESFJ, and then determine a mean time before an adverse condition after the occurrence of RD from RDESFJ, and so forth.

In some embodiments, implementation module 310 may be configured to implement the identified corrective action based at least in part on the event severity level, the pattern severity level, the rank of the particular pattern of events, the calculated time period, the estimated mean time before the adverse condition occurs, a cost of the corrective action, a cost of implementing the corrective action immediately versus a cost of implementing the corrective action after waiting a predetermined time period, current storage system performance, a service agreement, a device warranty, or any combination thereof. In some cases, implementation module 310 may automatically implement a predetermined corrective action upon detecting one or more events from a sequence of events known to result in an adverse condition. In some cases, the corrective action may include at least one of deleting a file, downloading a file, implementing a file, saving a file in a file system folder stored on a storage medium of the storage system, saving a file in a certain location of the storage medium of the storage system, installing a program, updating a program, installing firmware, upgrading firmware, repairing a hardware component, replacing a hardware component, sending a notification, or any combination thereof.

As one example, analysis module may determine that sequence JTZQD results in at least one adverse condition. In some cases, the adverse condition may be the last event D. Alternatively, the adverse condition may occur as a result of or based on event D occurring. In some embodiments, analysis module 305 may first detect event J then detect event T. Upon detecting J then T, analysis module 305 may determine that JT matches the first two events from the sequence JTZQD. In one embodiment, analysis module 305 may compute a probability of Z occurring after the occurrence of JT. In some cases, analysis module 305 may compute the probability of an event other than Z occurring after the occurrence of JT. In some cases, a severity level may be assigned to events JT based on the calculated probability of Z occurring. In some embodiments, the calculated probability may be based on a configuration of a storage system, current conditions of the storage system, etc. When the probability of Z occurring after JT is more than likely, then the severity level of JT may be increased. In some cases, estimation module 320 may calculate an expected time period between the occurrence of Z after the occurrence of JT. In some embodiments, implementation module 310 may compute a cost of implementing a corrective action after JT occurs versus a cost of implementing a corrective action after JTZ occurs, versus a cost of implementing a corrective action after JTZQ occurs, etc. In some cases, implementation module 310 may identify a service policy or service agreement associated with a particular storage system and determine what corrective action to take and when to take it based at least in part on the service agreement.

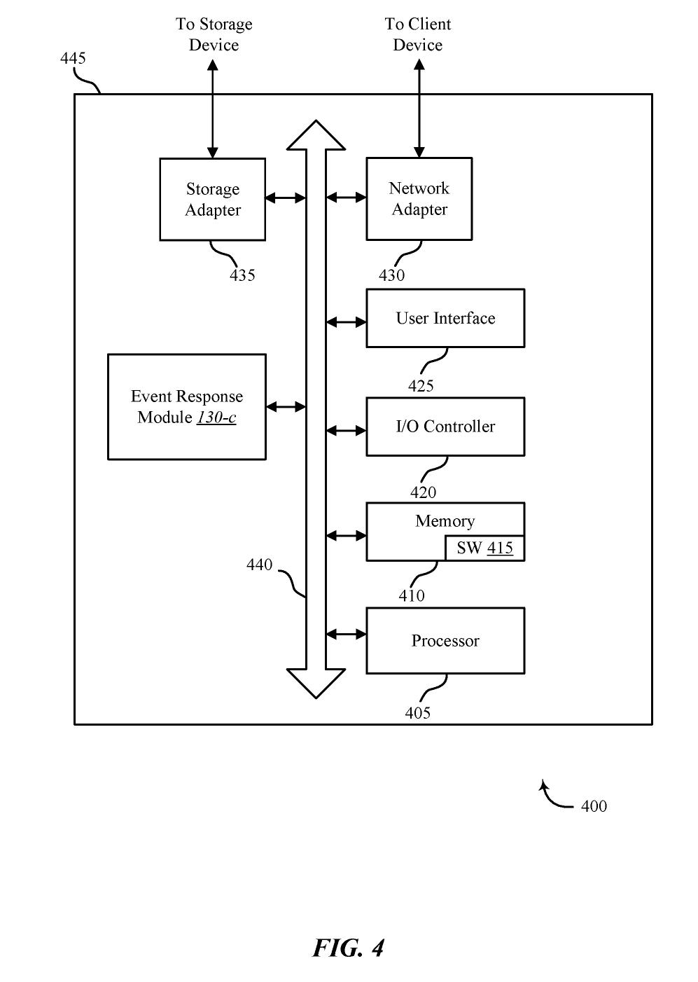

FIG. 4 shows a system 400 for a self-learning event response engine of systems, in accordance with various examples. System 400 may include an apparatus 445, which may be an example of any one of device 105 of FIG. 1 and/or device 205 of FIG. 2.

Apparatus 445 may include components for bi-directional voice and data communications including components for transmitting communications and components for receiving communications. For example, apparatus 445 may communicate bi-directionally with one or more storage devices and/or client systems. This bi-directional communication may be direct (apparatus 445 communicating directly with a storage system, for example) and/or indirect (apparatus 445 communicating indirectly with a client device through a server, for example).

Apparatus 445 may also include a processor module 405, and memory 410 (including software/firmware code (SW) 415), an input/output controller module 420, a user interface module 425, a network adapter 430, and a storage adapter 435. The software/firmware code 415 may be one example of a software application executing on apparatus 445. The network adapter 430 may communicate bi-directionally, via one or more wired links and/or wireless links, with one or more networks and/or client devices. In some embodiments, network adapter 430 may provide a direct connection to a client device via a direct network link to the Internet via a POP (point of presence). In some embodiments, network adapter 430 of apparatus 445 may provide a connection using wireless techniques, including digital cellular telephone connection, Cellular Digital Packet Data (CDPD) connection, digital satellite data connection, and/or another connection. The apparatus 445 may include an event response module 130-c, which may perform the functions described above for the event response module 130 of FIGS. 1, 2, and/or 3.

The signals associated with system 400 may include wireless communication signals such as radio frequency, electromagnetics, local area network (LAN), wide area network (WAN), virtual private network (VPN), wireless network (using 802.11, for example), cellular network (using 3G and/or LTE, for example), and/or other signals. The network adapter 430 may enable one or more of WWAN (GSM, CDMA, and WCDMA), WLAN (including BLUETOOTH® and Wi-Fi), WMAN (WiMAX) for mobile communications, antennas for Wireless Personal Area Network (WPAN) applications (including RFID and UWB), or any combination thereof.

One or more buses 440 may allow data communication between one or more elements of apparatus 445 such as processor module 405, memory 410, I/O controller module 420, user interface module 425, network adapter 430, and storage adapter 435, or any combination thereof.

The memory 410 may include random access memory (RAM), read only memory (ROM), flash memory, and/or other types. The memory 410 may store computer-readable, computer-executable software/firmware code 415 including instructions that, when executed, cause the processor module 405 to perform various functions described in this disclosure. Alternatively, the software/firmware code 415 may not be directly executable by the processor module 405 but may cause a computer (when compiled and executed, for example) to perform functions described herein. Alternatively, the computer-readable, computer-executable software/firmware code 415 may not be directly executable by the processor module 405, but may be configured to cause a computer, when compiled and executed, to perform functions described herein. The processor module 405 may include an intelligent hardware device, for example, a central processing unit (CPU), a microcontroller, an application-specific integrated circuit (ASIC), field programmable gate array (FPGA), or any combination thereof.

In some embodiments, the memory 410 may contain, among other things, the Basic Input-Output system (BIOS) which may control basic hardware and/or software operation such as the interaction with peripheral components or devices. For example, at least a portion of the event response module 130-c to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface such as network adapter 430.

Many other devices and/or subsystems may be connected to and/or included as one or more elements of system 400 (for example, a personal computing device, mobile computing device, smart phone, server, internet-connected device, cell radio module, or any combination thereof). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be a mobile device operation system, a desktop/laptop operating system, or another known operating system.

The I/O controller module 420 may operate in conjunction with network adapter 430 and/or storage adapter 435. The network adapter 430 may enable apparatus 445 with the ability to communicate with client devices such as device 105 of FIG. 1, and/or other devices over a communication network. Network adapter 430 may provide wired and/or wireless network connections. In some cases, network adapter 430 may include an Ethernet adapter or Fibre Channel adapter. Storage adapter 435 may enable apparatus 445 to access one or more data storage devices such as storage media 110. The one or more data storage devices may include two or more data tiers each. The storage adapter 445 may include one or more of an Ethernet adapter, a Fibre Channel adapter, Fibre Channel Protocol (FCP) adapter, a SCSI adapter, and iSCSI protocol adapter.

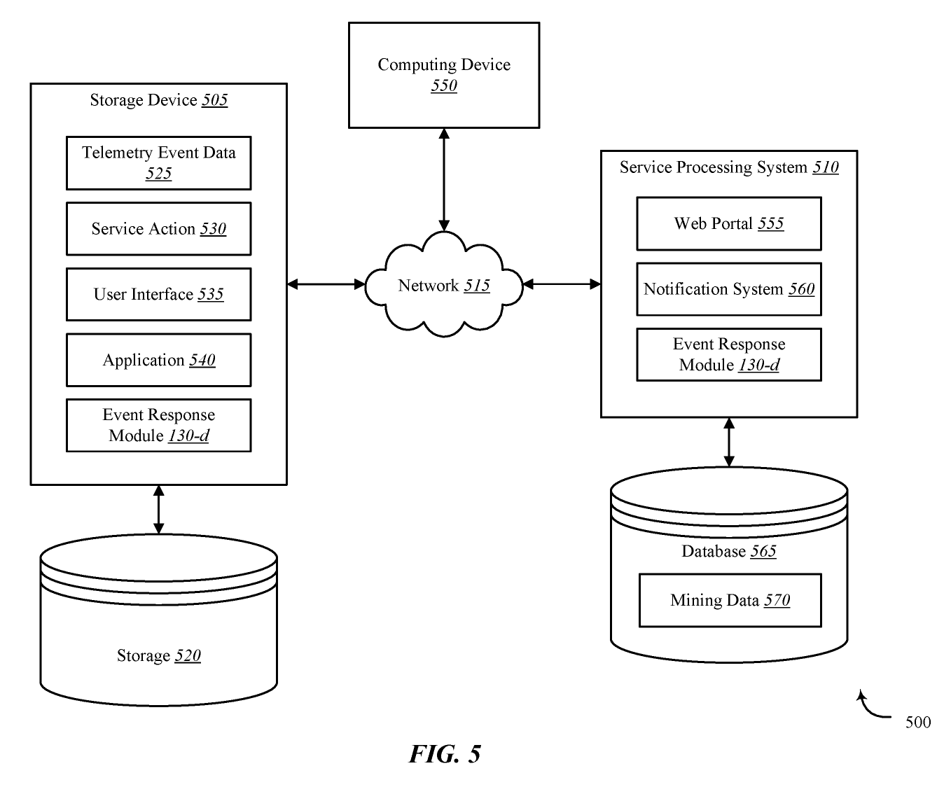

FIG. 5 shows a diagram of a system 500 for a self-learning event response engine of systems, in accordance with various examples. At least one aspect of system 500 may be implemented in conjunction with device 105 of FIG. 1, apparatus 205 of FIG. 2, and/or event response module 130 depicted in FIGS. 1, 2, 3, and/or 4.

In some embodiments, the systems and methods described herein may be performed on a device (e.g., storage device 505). As depicted, the system 500 may include a storage device 505, service processing system 510, a computing device 550, and a network 515 that allows the storage device 505, the service processing system 510, and the computing device 550 to communicate with one another.

Examples of the storage device 505 may include a storage enclosure containing two or more storage drives, a storage server, a distributed storage device, a cloud storage device, or any combination thereof. As shown, storage device 505 may include storage device 520. Storage device 520 may include any number of hard disk drives, solid state drives, hybrid drives with a mix of hard disk storage media and solid state storage media, or any combination thereof. Storage device 520 may be internal or external to storage device 505 or a combination thereof.

In some configurations, the storage device 505 may include telemetry event data 525, service action 530, user interface 535, application 540, and event response module 130-d. Although the components of the storage device 505 are depicted as being internal to the storage device 505, it is understood that one or more of the components may be external to the storage device 505 and connect to storage device 505 through wired and/or wireless connections. In some embodiments, application 540 may be installed on computing device 550 in order to enable a remote machine such as computing device 550 to interface with a function of storage device 505, event response module 130-d, and/or service processing system 510.

In one embodiment, storage device 505 generates telemetry event data 525 each time storage device 505 determines a predetermined storage event occurs. In some embodiments, storage device 505 may process at least a portion of telemetry event data 525. In some cases, storage device 505 may send over network 515 telemetry event data 525 to service processing system 510 to enable service processing system 510 to process at least a portion of telemetry event data 525. Although system 500 depicts telemetry event data 525 from a single storage device 505, it is understood that telemetry event data 525 may be generated by multiple storage systems. Thus, service processing system 510 may receive telemetry data 525 from storage device 505 and additional telemetry data from one or more additional storage devices.

In some cases, one or more functions of storage device 505 and/or service processing system 510 may be invoked by computing device 550. Examples of computing device 550 may include any combination of a mobile computing device, a laptop, a desktop, a server, a media set top box, or any combination thereof.

In some embodiments, storage device 505 may communicate with service processing system 510 via network 515. Examples of service processing system 510 may include any combination of a mobile computing device, a laptop computer, a desktop computer, a data server, a cloud server, proxy server, mail server, web server, application server, database server, communications server, file server, home server, mobile server, name server, or any combination thereof. Examples of network 515 may include any combination of cloud networks, local area networks (LAN), wide area networks (WAN), virtual private networks (VPN), wireless networks (using 802.11, for example), cellular networks (using 3G and/or LTE, for example), etc. In some configurations, the network 515 may include the Internet.

It is noted that in some embodiments, the storage device 505 may not include an event response module 130-d. In some embodiments, storage device 505 and service processing system 510 may include an event response module 130-d where at least a portion of the functions of event response module 130-d are performed separately and/or concurrently on storage device 505 and/or service processing system 510. Likewise, in some embodiments, a user may access the functions of storage device 505 (directly or through storage device 505 via event response module 130-d) from computing device 550. For example, in some embodiments, computing device 550 includes a mobile application that interfaces with one or more functions of storage device 505 event response module 130-d, and/or service processing system 510.

As depicted, service processing system 510 may include web portal 555, notification system 560, and event response module 130-d. In some embodiments, web portal 555 may enable a computing device to establish a connection with service processing system 510 and/or control one or more operations or functions of service processing system 510. For example, web portal 555 may enable computing storage device 505 and/or computing device 550 to establish a connection with service processing system 510.

In some cases, service processing system 510 may receive telemetry event data 525 from storage device 505. In some embodiments, service processing system 510, in conjunction with event response module 130-d, may process the received telemetry event data 525 and generate a service action. In some cases, notification system 560 may send the generated service action to storage device 505 over network 515. For example, storage device 505 may receive service action 530 from notification system 560 and implement the received service action 530 to remedy an issue affecting an operation of storage device 505 as determined by analysis of telemetry event data 525.

In some embodiments, service processing system 510 may be coupled to database 565. Database 565 may include mining data 570. Database 565 may be internal or external to the service processing system 510. In some cases, storage device 505 may access mining data 570 in database 520 over network 515 via service processing system 510. In one example, storage device 505 may be coupled directly to database 565, database 565 being internal or external to storage device 505. In some embodiments, mining data 570 may be generated based on telemetry event data 525. In some cases, mining data 570 may include identified patterns of events that are determined to result in adverse conditions in relation to storage device 505. As one example, storage device 505 may send telemetry event data 525 to service processing system 510. Service processing system 510 may process and/or analyze the received telemetry event data 525 and derive mining data 570 from the processed and/or analyzed telemetry event data 525. For example, service processing system 510 may identify one or more frequently occurring events in event data 525 that affect the operation of storage device 505 such as adverse conditions, errors, or failures associated with storage device 505 and/or storage device 520.

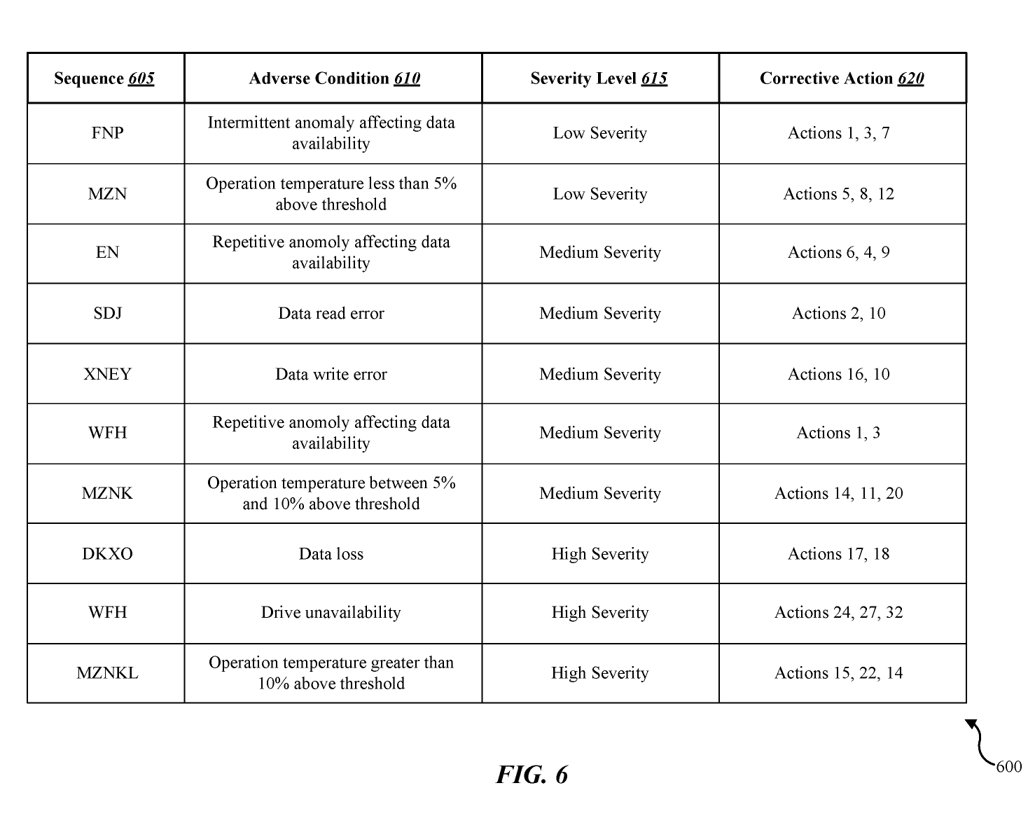

FIG. 6 shows a diagram of database entries 600 in accordance with various aspects of this disclosure. At least one aspect of database entries 600 may be derived from and/or implemented in conjunction with device 105 of FIG. 1, apparatus 205 of FIG. 2, and/or event response module 130 depicted in FIGS. 1, 2, 3, 4, and/or 5. In some cases, database entries 600 may be one example of mining data 570 of FIG. 5.

As depicted, database entries 600 may include multiple entries partitioned by predetermined categories. For example, an entry may be partitioned by sequence 605, adverse condition 610, severity level 615, and corrective action 620. In some embodiments, the severity level may include two or more severity levels. For example, the severity levels may include a high severity and a low severity. As one example, the severity levels may include a low severity, a medium severity, and a high severity, as illustrated in FIG. 6. In some cases, a severity level may apply to a single event. Additionally, or alternatively, a severity level may apply to a particular sequence of events.

As shown, database entries 600 may include an entry for a pattern of events that includes the sequence FNP. The adverse condition of the sequence FNP may include an intermittent anomaly that affects data availability. The sequence FNP may be assigned a low severity level based on the determined seriousness of the associated adverse condition. As shown, the sequence FNP may include corrective actions 1, 3 or 7. In one embodiment, one of the actions may be a preferred corrective action. For example, action 1 may be preferred, and actions 3 and 7 may be alternative corrective actions. In some cases, action 1 may be a first action to implement and actions 3 and/or 7 may be further actions to implement based on the result of implementing action 1. For example, action 3 may be implemented when action 1 is deemed to be unsuccessful, and so forth. Likewise, database entries 600 may include other entries sorted according to a given sequence 605, adverse condition 610, severity level 615, corrective action 620, or any combination thereof.

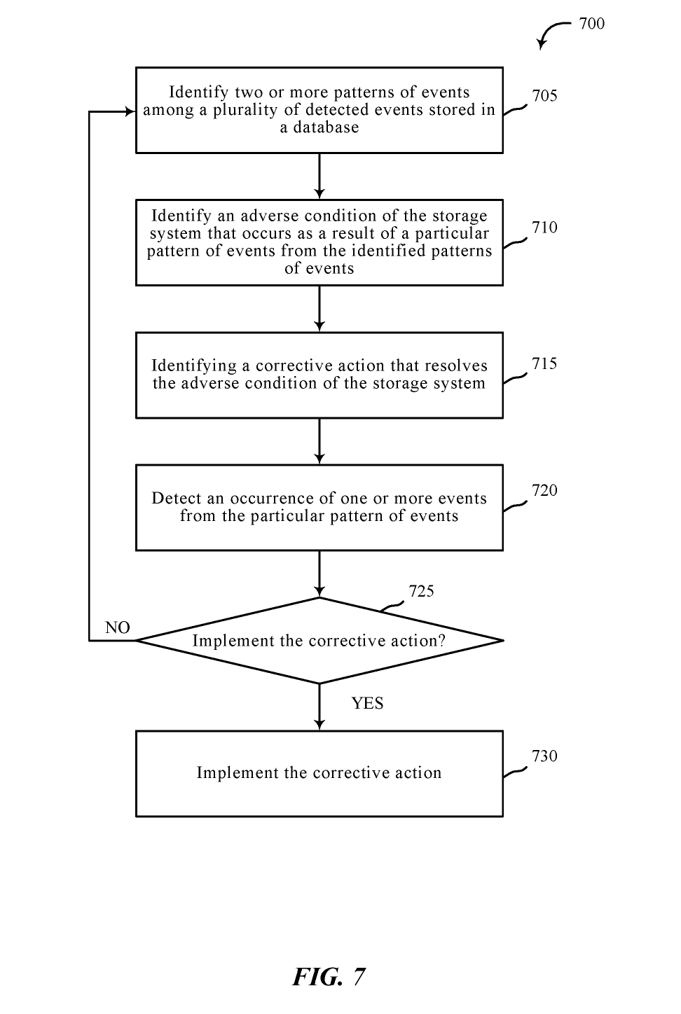

FIG. 7 is a flow chart illustrating an example of a method 700 for a self-learning event response engine of systems, in accordance with various aspects of the present disclosure. One or more aspects of the method 700 may be implemented in conjunction with device 105 of FIG. 1, apparatus 205 of FIG. 2, and/or event response module 130 depicted in FIGS. 1, 2, 3, 4 and/or 5. In some examples, a backend server, computing device, and/or storage device may execute one or more sets of codes to control the functional elements of the backend server, computing device, and/or storage device to perform one or more of the functions described below. Additionally or alternatively, the backend server, computing device, and/or storage device may perform one or more of the functions described below using special-purpose hardware.

At block 705, the method 700 may include identifying two or more patterns of events among a plurality of detected events stored in a database. At block 710, the method 700 may include identifying an adverse condition of the storage system that occurs as a result of a particular pattern of events from the identified patterns of events. At block 715, the method 700 may include identifying a corrective action that resolves the adverse condition of the storage system.

At block 720, the method 700 may include detecting an occurrence of one or more events from the particular pattern of events. At block 725, the method 700 may include determining whether to implement a corrective action based at least in part on detecting the occurrence of the one or more events from the particular pattern of events. Upon determining a corrective action is not warranted for one or more reasons such as a cost of the corrective action, etc., method 700 may forego implementing a corrective action and may continue monitoring at block 705 for sequences of events that match known patterns of events that result in adverse conditions. At block 730, upon determining to implement a corrective action, method 700 may implement a prescribed corrective action based at least in part on detecting the occurrence of the one or more events from the particular pattern of events.

The operation(s) of method 700 shown in FIG. 7 may be performed using the event response module 130 described with reference to FIGS. 1-5 and/or another module. Thus, the method 700 may provide for a self-learning event response engine of systems relating to a self-learning event response engine of systems. It should be noted that the method 700 is just one implementation and that the operations of the method 700 may be rearranged, omitted, and/or otherwise modified such that other implementations are possible and contemplated.

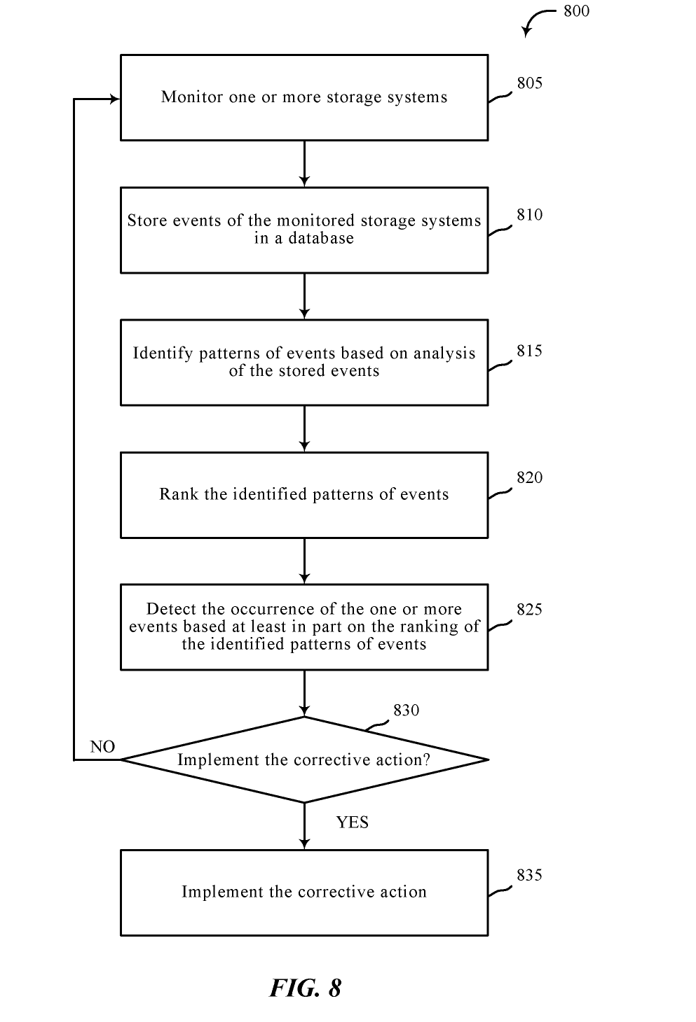

FIG. 8 is a flow chart illustrating an example of a method 800 for a self-learning event response engine of systems, in accordance with various aspects of the present disclosure. One or more aspects of the method 800 may be implemented in conjunction with device 105 of FIG. 1, apparatus 205 of FIG. 2, and/or event response module 130 depicted in FIGS. 1, 2, 3, 4 and/or 5. In some examples, a backend server, computing device, and/or storage device may execute one or more sets of codes to control the functional elements of the backend server, computing device, and/or storage device to perform one or more of the functions described below. Additionally or alternatively, the backend server, computing device, and/or storage device may perform one or more of the functions described below using special-purpose hardware.

At block 805, the method 800 may include monitoring one or more storage systems. At block 810, the method 800 may include storing events of the monitored storage systems in a database. At block 815, the method 800 may include identifying patterns of events based on analysis of the stored events. At block 820, the method 800 may include ranking the identified patterns of events. For example, method 800 may rank the identified patterns of events based at least in part on their frequency of occurrence, an event severity level, a pattern severity level, or any combination thereof.

At block 825, the method 800 may include detecting the occurrence of the one or more events based at least in part on the ranking of the identified patterns of events. For example, method 800 may rank the detected patterns of events and then monitor occurrences of events for only a portion of the ranked detected patterns. For example, method 800 may detect occurrences of one or more events if the events are part of a top portion of most frequent patterns of events such as the top 100 patterns of events, while ignoring sequences of events that match patterns that fall below the top 100 patterns of events, as one example. In one example, method 800 may rank patterns of events based on a severity of an adverse condition that results from the pattern or whether or not an adverse condition results from the pattern. In some cases, method 800 may only search for sequences of events that match the initial events of patterns of events that result in an adverse condition of a certain severity or a severity above a predetermined severity threshold. In some cases, method 800 may ignore sequences of events that are part of patterns of events that do not result in an adverse condition.

At block 830, the method 800 may include determining whether to implement a corrective action based at least in part on detecting the occurrence of the one or more events from the particular pattern of events. Upon determining a corrective action is not warranted for one or more reasons such as a cost of the corrective action based on the events that have so far occurred, etc., method 800 may forego implementing a corrective action and may continue monitoring at block 805 for sequences of events that match known patterns of events that result in adverse conditions. For example, method 800 may detect the sequence of events PAF from the pattern of events PAFZLE. After detecting the sequence PAF, method 800 may determine it is more cost effective to wait and see if event Z occurs after PAF, and then implement a corrective action upon detecting PAFZ or upon detecting PAFZL, etc. At block 835, upon determining to implement a corrective action, method 800 may implement a prescribed corrective action based at least in part on detecting the occurrence of the one or more events from the particular pattern of events.

The operation(s) of the method 800 shown in FIG. 8 may be performed using the event response module 130 described with reference to FIGS. 1-5 and/or another module. Thus, the method 800 may provide for a self-learning event response engine of systems relating to a self-learning event response engine of systems. It should be noted that the method 800 is just one implementation and that the operations of the method 800 may be rearranged, omitted, and/or otherwise modified such that other implementations are possible and contemplated.

In some examples, aspects from two or more of the methods 700 and 800 may be combined and/or separated. It should be noted that the methods 700 and 800 are just example implementations, and that the operations of the methods 700 and 800 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, for example, a combination of a DSP and a microprocessor, multiple microprocessors, one or more microprocessors in conjunction with a DSP core, and/or any combination thereof.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC, or A and B and C.

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, or any combination thereof, then the coaxial cable, fiber optic cable, twisted pair, DSL, or wireless technologies such as infrared, radio, and/or microwave are included in the definition of medium. Disk and disc, as used herein, include any combination of compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein, but is to be accorded the broadest scope consistent with the principles and novel features disclosed.

This disclosure may specifically apply to security system applications. This disclosure may specifically apply to storage system applications. In some embodiments, the concepts, the technical descriptions, the features, the methods, the ideas, and/or the descriptions may specifically apply to storage and/or data security system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A storage system comprising:
a hardware controller configured to:
identify two or more patterns of events among a plurality of detected events and an adverse condition of the storage system that occurs as a result of a particular pattern of events from the identified patterns of events;
select a corrective action that resolves the adverse condition;
detect an occurrence of one or more events from the particular pattern of events; and
implement the corrective action based at least in part on detecting the occurrence of the one or more events from the particular pattern of events.

2. The storage system of claim 1, wherein each pattern of events includes a sequence of two or more events in a given order related to operations of the storage system, the storage system comprising a storage drive, a storage server, a storage enclosure enclosing two or more storage drives, a distributed data storage system, a cloud storage system, or any combination thereof.

3. The storage system of claim 1, wherein the adverse condition includes an abnormal operation of the storage system, an abnormal operating condition of the storage system, a hardware failure, a software bug, a firmware bug, unavailability of the storage system, a loss of data stored on the storage system, or any combination thereof.

4. The storage system of claim 1, wherein the plurality of detected events comprises an event type, an event trigger, an event severity level, a pattern severity level, or any combination thereof.

5. The storage system of claim 4, wherein the hardware controller is further configured to:
rank the identified patterns of events based at least in part on their frequency of occurrence, the event severity level, the pattern severity level, or any combination thereof.

6. The storage system of claim 5, wherein the hardware controller is further configured to:
detect the occurrence of the one or more events being based at least in part on the ranking of the identified patterns of events.

7. The storage system of claim 5, wherein the hardware controller is further configured to:
calculate a time period expected to lapse between two events in the particular pattern of events; and
estimate, based at least in part on the time period, a mean time before the adverse condition occurs in relation to detecting the occurrence of the one or more events from the particular pattern of events.

8. The storage system of claim 7, wherein the hardware controller is further configured to:
implement the corrective action based at least in part on the event severity level, the pattern severity level, the rank of the particular pattern of events, the time period, the estimated mean time before the adverse condition occurs, a cost of the corrective action, a cost of implementing the corrective action immediately versus a cost of implementing the corrective action after waiting a predetermined time period, current storage system performance, a service agreement, a device warranty, or any combination thereof.

9. The storage system of claim 4, wherein the event severity level of the particular pattern of events is based at least in part on a position of a specific event from the particular pattern of events relative to other events in the particular patterns of events, and the pattern severity level of the particular pattern of events being based at least in part on a severity of the adverse condition caused by the particular pattern of events.

10. The storage system of claim 1, wherein the corrective action includes at least one of deleting a file, downloading a file, implementing a file, saving a file in a file system folder stored on a storage medium of the storage system, saving a file in a certain location of the storage medium of the storage system, installing a program, updating a program, installing firmware, upgrading firmware, repairing a hardware component, replacing a hardware component, sending a notification, or any combination thereof.

11. A storage system method, comprising:
identifying two or more patterns of events among a plurality of detected events stored in a database;
identifying an adverse condition of the storage system that occurs as a result of a particular pattern of events from the identified patterns of events;
identifying a corrective action that resolves the adverse condition of the storage system;
detecting an occurrence of one or more events from the particular pattern of events; and
implementing the corrective action based at least in part on detecting the occurrence of the one or more events from the particular pattern of events.

12. The storage system method of claim 11, wherein each pattern of events includes a sequence of two or more events in a given order related to operations of the storage system, the storage system comprising a storage drive, a storage server, a storage enclosure enclosing two or more storage drives, a distributed data storage system, a cloud storage system, or any combination thereof.

13. The storage system method of claim 11, wherein the adverse condition includes an abnormal operation of the storage system, an abnormal operating condition of the storage system, a hardware failure, a software bug, a firmware bug, unavailability of the storage system, a loss of data stored on the storage system, or any combination thereof.

14. The storage system method of claim 11, wherein the plurality of detected events stored in the database comprises an event type, an event trigger, an event severity level, a pattern severity level, or any combination thereof.

15. The storage system method of claim 14, further comprising:
ranking the identified patterns of events based at least in part on their frequency of occurrence, the event severity level, the pattern severity level, or any combination thereof; and
detecting the occurrence of the one or more events being based at least in part on the ranking of the identified patterns of events.

16. The storage system method of claim 15, further comprising:
calculating a time period expected to lapse between two events in the particular pattern of events; and
estimating, based at least in part on the calculated time period, a mean time before the adverse condition occurs in relation to detecting the occurrence of the one or more events from the particular pattern of events.

17. The storage system method of claim 16, further comprising:
implementing the identified corrective action based at least in part on the event severity level, the pattern severity level, the rank of the particular pattern of events, the time period, the estimated mean time before the adverse condition occurs, a cost of the corrective action, a cost of implementing the corrective action immediately versus a cost of implementing the corrective action after waiting a predetermined time period, current storage system performance, a service agreement, a device warranty, or any combination thereof.

18. The storage system method of claim 14, wherein the event severity level of the particular pattern of events is based at least in part on a position of a specific event from the particular pattern of events relative to other events in the particular patterns of events, and the pattern severity level of the particular pattern of events being based at least in part on a severity of the adverse condition caused by the particular pattern of events.

19. A non-transitory computer-readable storage medium storing computer executable instructions to improve a computer system that when executed by a processor cause the processor to perform the steps of:
identifying two or more patterns of events among a plurality of detected events stored in a database, each pattern of events including a sequence of two or more events in a given order related to operations of a storage system;
identifying an adverse condition of the storage system that occurs as a result of the identified patterns of events;
selecting a corrective action that resolves the adverse condition of the storage system; and
implementing the corrective action.

20. The storage medium of claim 19, wherein the storage system comprises a storage drive, a storage server, a storage enclosure enclosing two or more storage drives, a distributed data storage system, a cloud storage system, or any combination thereof.
